(19) United States
(12) Patent Application Publication
(10) Pub. No.: US 2025/0322237 A1
(43) Pub. Date: Oct. 16, 2025

(54) LEARNING EMBEDDINGS SUBJECT TO AN INVARIANCE CONSTRAINT BETWEEN SCORE DISTRIBUTIONS

(71) Applicant: GDM Holding LLC, Mountain View, CA (US)

(72) Inventors: Jovana Mitrovic, London (GB); Brian McWilliams, London (GB)

(21) Appl. No.: 19/249,049

(22) Filed: Jun. 25, 2025

Related U.S. Application Data
(63) Continuation of application No. 17/338,938, filed on Jun. 4, 2021.
(60) Provisional application No. 63/035,524, filed on Jun. 5, 2020.

(51) Int. Cl. G06N 3/08; G06N 3/04

(52) U.S. Cl. CPC G06N 3/08; G06N 3/04

(57) ABSTRACT

Methods, systems, and apparatus, including computer programs encoded on a computer storage medium, for training an embedding neural network based on score distributions. In one aspect, a system comprises: generating a first and second embedding of a data element, comprising: applying a first and second transformation to the data element to generate a respective first and second version of the data element and processing the respective versions using the embedding neural network to generate the respective first and second embeddings; generating, for the data element, a respective first and respective second score distribution, comprising: processing at least the first and the second embedding to generate the first and the second score distribution, respectively; and updating the current embedding network parameter values to optimize an objective function that is based on at least the first score distribution, that encourages a similarity between: (i) the first, and (ii) the second score distribution.

### CROSS-REFERENCE TO RELATED APPLICATION

This application is a continuation of U.S. patent application Ser. No. 17/338,938, filed on Jun. 4, 2021, which claims priority under 35 USC § 119(e) to U.S. Patent Application Ser. No. 63/035,524, filed on Jun. 5, 2020, the entire contents of which are hereby incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that trains an embedding neural network having a plurality of embedding neural network parameters that is configured to process a data element to generate an embedding of the data element.

As used throughout this document, an “embedding” can refer to an ordered collection of numerical values, e.g., a vector or matrix of numerical values.

According to a first aspect there is provided a method performed by one or more data processing apparatus for training an embedding neural network having a plurality of parameters that is configured to process a data element to generate an embedding of the data element, the method comprising: generating a first embedding and a second embedding of a data element, comprising: applying a first transformation to the data element to generate a first version of the data element and processing the first version of the data element using the embedding neural network to generate the first embedding of the data element, and applying a second transformation to the data element to generate a second version of the data element and processing the second version of the data element using the embedding neural network to generate the second embedding of the data element; generating, for the data element, a respective first score distribution and a respective second score distribution over a set of given data elements that includes the data element, comprising: processing at least the first embedding of the data element to generate the first score distribution over the set of given data elements, and processing at least the second embedding of the data element to generate the second score distribution over the set of given data elements; and updating current values of the embedding neural network parameters to optimize an objective function that measures a similarity between: (i) the first score distribution, and (ii) the second score distribution.

In some implementations, processing at least the first embedding of the data element to generate the first score distribution over the set of given data elements comprises: generating a respective embedding of each other data element in the set of given data elements other than the data element, comprising, for each other data element: applying a first other transformation to the other data element to generate a version of the other data element and processing the version of the other data element using the embedding neural network to generate the embedding of the other data element; generating the first score distribution over the set of given data elements based on both: (i) the first embedding of the data element, and (ii) the respective embedding of each other data element.

In some implementations, generating the first score distribution over the set of given data elements comprises, for each given data element: generating a score for the given data element based on a similarity between: (i) the first embedding of the data element, and (ii) the embedding of the given data element.

In some implementations, generating the score for the given data element based on the similarity between: (i) the first embedding of the data element, and (ii) the embedding of the given data element comprises: processing the first embedding of the data element by a projection neural network to generate a projection of the first embedding of the data element; processing the embedding of the given data element by the projection neural network to generate a projection of the embedding of the given data element; and generating the score for the given data element based on a similarity measure between: (i) the projection of the first embedding of the data element, and (ii) the projection of the embedding of the given data element.

In some implementations, generating the score for the given data element based on the similarity measure between: (i) the projection of the first embedding of the data element, and (ii) the projection of the embedding of the given data element comprises: determining a ratio of: (i) the similarity measure, and (ii) a temperature parameter; and applying an exponential function to a result of the ratio.

In some implementations, the objective function comprises a contrastive loss term, wherein the contrastive loss term measures an error between: (i) the first score distribution over the set of given data elements, and (ii) the data element.

In some implementations, the error between: (i) the first score distribution over the set of possible outputs, and (ii) the data element, comprises a ratio of a numerator and a denominator, wherein: the numerator comprises the score from the first score distribution for the data element, and the denominator comprises a sum of the scores from the first score distribution.

In some implementations, the objective function comprises an invariance term that measures the similarity between: (i) the first score distribution, and (ii) the second score distribution.

In some implementations, the objective function comprises a linear combination of the contrastive loss term and the invariance term.

In some implementations, processing at least the second embedding of the data element to generate the second score distribution over the set of given data elements comprises: generating a respective second other embedding of each other data element in the set of given data elements other than the data element, comprising, for each other data element: applying a second other transformation to the other data element to generate a version of the other data element and processing the version of the other data element using the embedding neural network to generate the second other embedding of the other data element; generating the second score distribution over the set of given data elements based on both: (i) the second embedding of the data element, and (ii) the respective second other embedding of each other data element.

In some implementations, the similarity between: (i) the first score distribution, and (ii) the second score distribution, is based on a divergence between: (i) the first score distribution, and (ii) the second score distribution.

In some implementations, the divergence is a Kullback-Leibler divergence.

In some implementations, the data element comprises an image.

In some implementations, the method further comprises sampling the first transformation and the second transformation from a set of possible transformations.

According to another aspect there is provided a system comprising: one or more computers; and one or more storage devices communicatively coupled to the one or more computers, wherein the one or more storage devices store instructions that, when executed by the one or more computers, cause the one or more computers to perform the operations of the methods described herein.

According to another aspect there are provided one or more non-transitory computer storage media storing instructions that when executed by one or more computers cause the one or more computers to perform the operations of the methods described herein.

Particular embodiments of the subject matter described in this specification can be implemented so as to realize one or more of the following advantages.

The system described in this specification can train an embedding neural network to generate effective embeddings (representations) of data elements that are useful for downstream tasks using unsupervised learning techniques, i.e., that do not rely on having access to labels or other additional data characterizing the data elements. The system trains the embedding neural network to optimize an objective function that encourages the embedding neural network to generate embeddings of data elements that result in “score distributions” which are invariant to transformations applied to the data elements. The system can generate a score distribution from a data element by applying a transformation to the data element, generating an embedding of the transformed data element, and then measuring a respective similarity between the data element embedding and each of multiple other data element embeddings. Such an objective function can be said to have an “invariance term” which encourages the embedding neural network to generate data element embeddings that consistently preserve the semantic content of data elements. Training the embedding neural network using an invariance term can increase the effectiveness of data element embeddings generated by the embedding neural network for downstream tasks, e.g., by enabling the downstream tasks to be performed with greater accuracy, efficiency, or both.

Training the embedding neural network using an objective function with an invariance term can enable the embedding neural network to generate acceptable data element embeddings (e.g., that result in an acceptable prediction accuracy in a downstream task) over fewer training iterations. Therefore, using the invariance term can reduce consumption of computational resources (e.g., memory and computing power) during training of the embedding neural network.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 is a flow diagram of an example process for training an embedding neural network.

FIG. 3 is a flow diagram of an example process for generating a first score distribution and a second score distribution for a selected data element.

FIG. 4 is a flow diagram of an example process for updating the values of the parameters of an embedding neural network.

Like reference numbers and designations in the various drawings indicate like elements.

### DETAILED DESCRIPTION

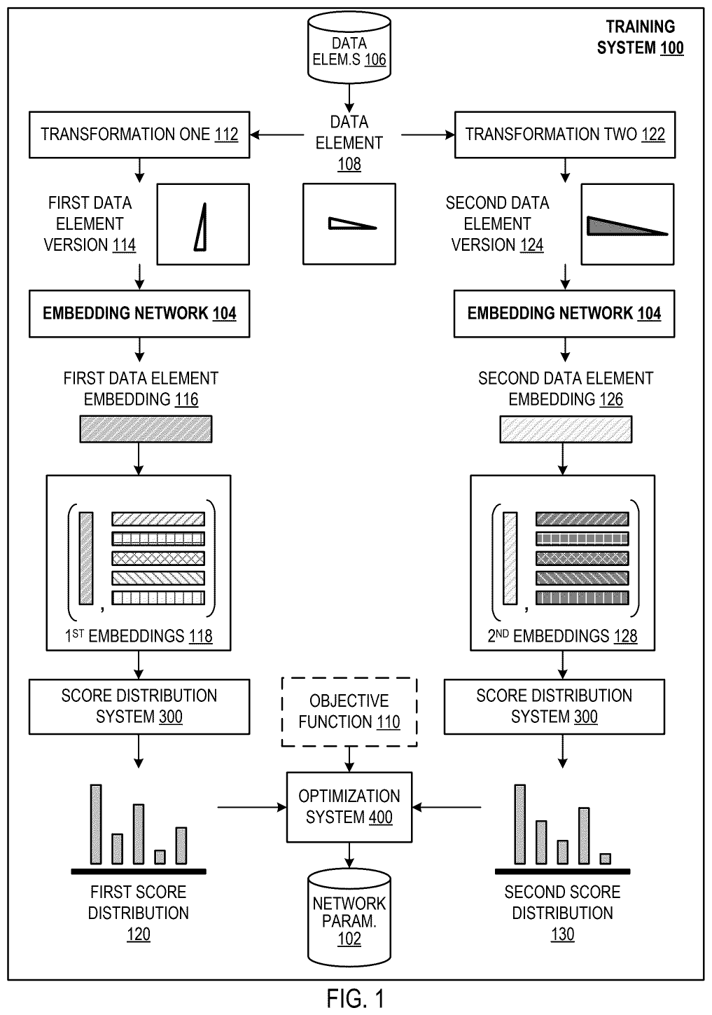

FIG. 1 shows an example training system 100. The training system 100 is an example of a system implemented as computer programs on one or more computers in one or more locations in which the systems, components, and techniques described below are implemented.

The training system 100 can train an embedding neural network to generate an embedding of a data element (e.g., an image) that is useful for subsequent tasks using unsupervised learning techniques, i.e., that do not rely on knowing labels for the data elements.

The training system 100 described herein is widely applicable and is not limited to one specific implementation. However, for illustrative purposes, a small number of example implementations are described below.

The embedding neural network can be configured to process any appropriate data element, e.g., image data elements, video data elements, text data elements, audio data elements, lidar data elements, hyper-spectral data elements, or a combination thereof. (Throughout this specification, processing an image, e.g., by a neural network, can refer to processing data defining the intensity values, e.g., color intensity values) associated with the pixels of the image).

The embedding neural network can have any appropriate neural network architecture that enables it to perform its described function, i.e., processing a data element to generate an embedding of the data element. In particular, the embedding neural network can include any appropriate types of neural network layers (e.g., fully-connected layers, attention-layers, convolutional layers, etc.) in any appropriate numbers (e.g., 1 layer, 5 layers, or 25 layers), and connected in any appropriate configuration (e.g., as a linear sequence of layers).

Data element embeddings that are generated by the trained embedding neural network can be used to perform any of a variety of downstream tasks. A few examples of using data element embeddings generated by the trained embedding neural network to perform downstream tasks are described in further detail below.

In one example, data element embeddings generated by the embedding neural network can be used to perform a classification task, i.e., where an embedding of a data element is processed to generate a respective score for each of multiple possible categories. The score for a category can define a likelihood that the data element is included in the category. For example, the data element can be an image, each category can correspond to a respective type of object, and the score for an object type can define a likelihood that the image depicts an object of the object type. As another example, the data element can be a segment of audio data, each category can correspond to a respective phoneme or grapheme, and the score for a phoneme or grapheme can define a likelihood that the audio data includes a verbalization of the phoneme or grapheme. As another example, the data element can be a video showing a person, each category can correspond to a possible action (e.g., running, walking, jumping, etc.), and the score for each action can define a likelihood that the video shows the person performing the action.

In another example, the data element embeddings generated by the embedding neural network can be used to perform a regression task, i.e., where an embedding of a data element is processed to generate one or more numerical values from continuous ranges of possible numerical values. For example, the data element can be a video showing a contraction of a heart, the embedding of the video can be processed to generate a numerical value that defines an estimate for the fraction of blood pumped out of the left ventricle of the heart during the contraction.

In another example, the data element embeddings generated by the embedding neural network can be used to perform an action selection task, i.e., to select actions to be performed by a reinforcement learning agent to interact with an environment. For example, the embedding neural network can be used to generate an embedding of an observation characterizing the state of the environment at a time step, and the embedding of the observation can be processed by an action selection neural network to generate an action selection output. The action selection output can be used to select the action to be performed by the agent in response to the observation. For example, the action selection output can include a respective score for each action in a set of possible actions, and the action having the highest score can be selected to be performed by the agent in response to the observation. The observation characterizing the state of the environment can include, e.g., image data, audio data, video data, lidar data, hyperspectral data, or any other appropriate sort of data.

In another example, data element embeddings generated by the embedding neural network can be used to perform an unsupervised clustering task. In an unsupervised clustering task, data element embeddings generated by the embedding neural network can be processed by a clustering engine to generate a (hard or soft) partition of the data element embeddings (and, by extension, the data elements themselves) into respective groups. The clustering engine can implement any appropriate clustering algorithm, e.g., an expectation-maximization (EM) or k-means clustering algorithm. The clustering can define a partition of the data elements into semantically meaningful groups, even in the absence of labels for the data elements.

Generally, the training system 100 iteratively updates the values of the network parameters 102 of an embedding neural network 104, i.e., over multiple training iterations, to optimize an objective function 110.

Before training begins, the training system 100 can initialize the values of the parameters of the embedding neural network in any appropriate manner, e.g., by initializing them randomly. The training system 100 can also receive a set of data elements 106. The set of data elements 106 can include multiple data elements of a particular type, e.g., images.

At each training iteration, the training system 100 can sample a data element 108 from the set of data elements 106. For example, the training system 100 can sample a data element randomly to ensure representative sampling of the data elements 106 over multiple training iterations.

At each training iteration, the training system 100 can sample (e.g., randomly) two transformations (e.g., transformation one 112 and transformation two 122) from a set of possible transformations. Generally, the sampled transformations can be different from each other, and can represent an intervention on the “style” of a data element. For example, the set of possible transformations for a data element representing, e.g., an image, can include, e.g., rotations (e.g., to a variety of possible rotation angles), color tinting (e.g., with a variety of different colors), gray scaling, expansion and cropping (using various expansion and cropping parameters), contraction and padding (using various contraction and padding parameters), pixel-wise noise (using various levels of noise), or any combination thereof.

At each training iteration, the training system 100 generates a respective first version and a respective second version of the sampled data element 108. The training system 100 can generate a respective first version 114 of the data element 108 using transformation one 112 and a respective second version 124 of the data element 108 using transformation two 122. Each respective version of the data element 108 can represent a new instance of data element 108, e.g., a cropped version of an image 108, a blue-tinted version of an image 108, or a rotated version of an image 108.

At each training iteration, the training system 100 can generate a respective first embedding and a respective second embedding of the data element 108 using an embedding neural network 104. For example, the training system 100 can generate a respective first embedding 116 of the data element 108 by processing the respective first version 114 of the data element 108 using the embedding neural network 104, and a respective second embedding 126 of the data element 108 by processing the respective second version 124 of the data element 108 using the same embedding neural network 104.

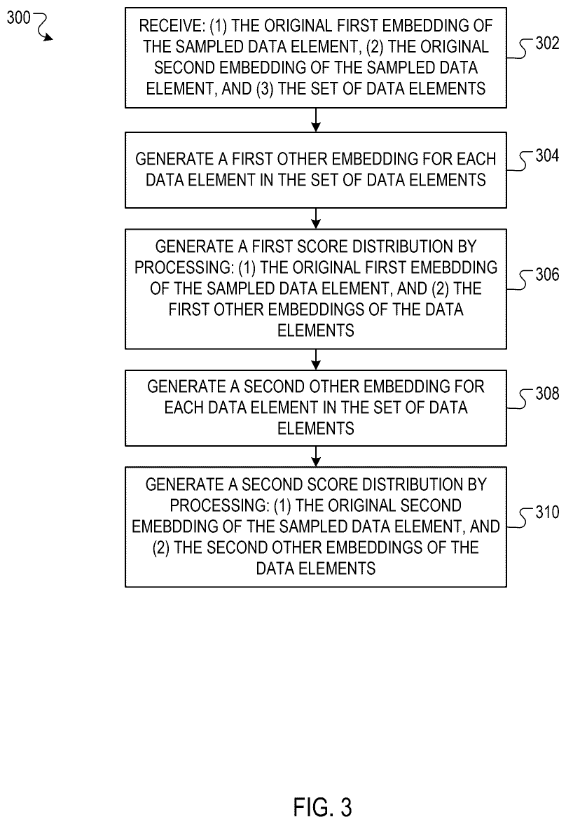

At each training iteration, the training system 100 can then generate a respective first set of data element embeddings 118 and a respective second set of data element embeddings 128. For example, the training system 100 can process each data element in the set of data elements 106 to generate a respective first set of data element embeddings and a respective second set of data element embeddings using a similar methodology used to generate the respective first data element embedding 116 and the respective second data element embedding 126, as will be discussed in further detail with reference to the description of FIG. 3 below.

At each training iteration, the score distribution system 300 can then generate a respective first score distribution 120 corresponding to the set of first data element embeddings 118 and a respective second score distribution 130 corresponding to the set of second data element embeddings 128. For example, the score distribution system 300 can generate a first score distribution based on: (i) the first data element embedding 116, and (ii) the first set of data element embeddings 118. The score distribution system 300 can generate each score in the first score distribution based on a similarity measure between the first data element embedding and a respective data element embedding from the first set of data element embeddings. The score distribution system 300 can generate a second score distribution based on: (i) the second data element embedding 126, and (ii) the second set of data element embeddings 128. The score distribution system 300 can generate each score in the second score distribution based on a similarity measure between the second data element embedding and a respective data element embedding from the second set of data element embeddings, as is described in further detail with reference to the description of FIG. 3 below.

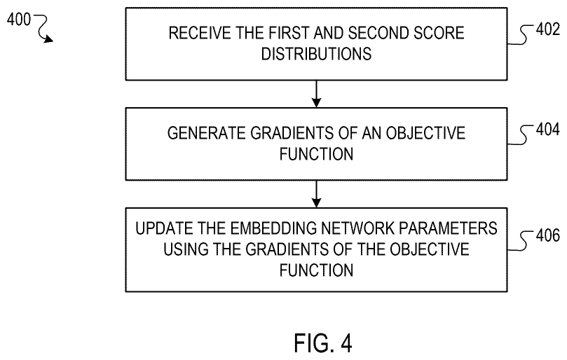

At each training iteration, the optimization system 400 can update the values of the network parameters 102 of the embedding neural network 104 to optimize an objective function 110 that depends on the first score distribution 120 and the second score distribution 130. For example, the objective function 110 can include a contrastive term that depends on at least the first score distribution 120 (e.g., which attempts to maximize the differences among data element embeddings generated from different data elements), as well as an “invariance” term which measures a similarity between the first score distribution 120 and second score distribution 130 (e.g., which attempts to minimize the differences among data element embeddings generated from different versions of the same data element), as will be described in further detail below with reference to the description of FIG. 4.

Training the embedding neural network 104 using an objective function with an invariance term can enable the embedding neural network to generate informative data element embeddings that preserve semantic content in data elements and that are useful for downstream tasks, without requiring any labels for the data elements.

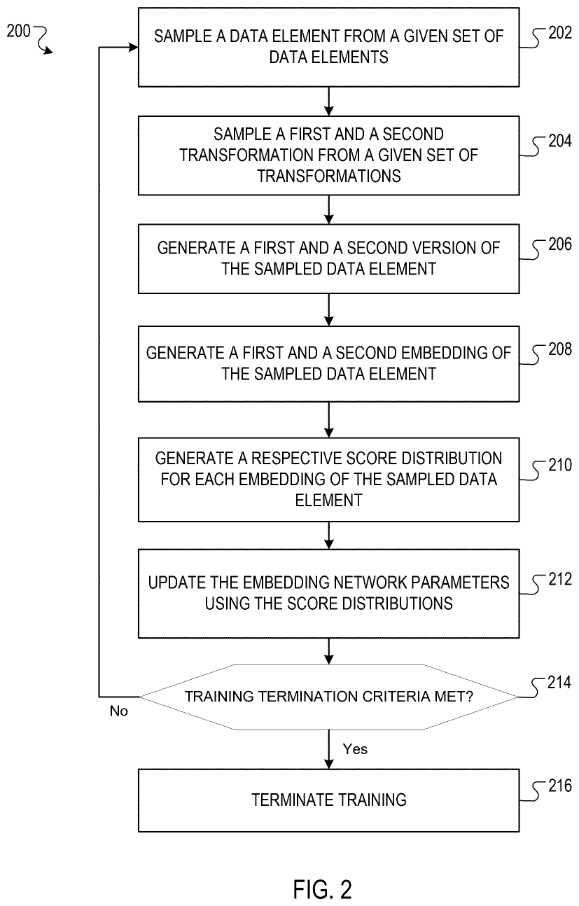

FIG. 2 is a flow diagram of an example process for training an embedding neural network. For convenience, the process 200 will be described as being performed by a system of one or more computers located in one or more locations. For example, a training system, e.g., the training system 100 of FIG. 1, appropriately programmed in accordance with this specification, can perform the process 200

At each training iteration, the training system samples a data element from a set of data elements (202). The data element can be sampled randomly from the set of data elements. The set of data elements can include multiple data elements of a specific type, e.g., image data elements.

At each training iteration, the training system samples a first and a second transformation (which are generally different) from a set of transformations (204). For example, the transformations can be sampled randomly to achieve a representative sampling of the set of transformations over multiple training iterations. For data elements which represent, e.g., images, the set of transformations can include, e.g., rotations (e.g., to a variety of possible rotation angles), color tinting (e.g., with a variety of different colors), gray scaling, expansion and cropping (using various expansion and cropping parameters), contraction and padding (using various contraction and padding parameters), pixel-wise noise (using levels strengths of noise), or any combination thereof.

At each training iteration, the training system generates a respective first version of the sampled data element and a respective second version of the sampled data element (206). The training system can generate the first version of the data element using the first transformation and the second version of the data element using the second transformation. In one example, each transformation can be represented by a corresponding matrix of numerical values that when applied to a data element (e.g., via matrix multiplication or element-wise multiplication) generates a corresponding version of the data element (e.g., a cropped version of the data element, a blue-tinted version of the data element, or a rotated version of the data element). The result of transformation l acting on data element i can be represented as,

$${x}_{i}^{{a}_{l}} = {T}_{l} ( {x}_{i} ) , \qquad ( 1 )$$

where i indexes the data elements, l indexes the transformations, Tₗ represents transformation l, aₗ denotes the augmentation conducted by transformation l,

$${x}_{i}^{{a}_{l}}$$

represents the version l of data element i under augmentation aₗ.

Each transformation on a data element can represent an intervention on the “style” of the data element while leaving the “content” of the data element unchanged. An augmentation does not change the underlying semantic information (“content”) represented by the data element (e.g., the index of the data element), but instead represents a “stylistic” change to generate a new version of the same data element. For example, for an image, the lighting, tint, angle, or relative size can be changed, while leaving the index of the data element unchanged, which can enable the training system to be trained using an instance discrimination task (i.e., using the data element index i as the target output), as will be described in more detail below.

At each training iteration, the training system generates a respective data element embedding for each version of the sampled data element (208). For example, the training system can generate each respective data element embedding using the embedding neural network, i.e., by generating the first data element embedding of the sampled data element by processing the first version of the sampled data element using the embedding neural network, and by generating the second data element embedding of the sampled data element by processing the second version of the sampled data element using the embedding neural network. Generating an embedding of a data element version can be represented as, e.g.:

$${e}_{i}^{{a}_{l}} = f ( {x}_{i}^{{a}_{l}} ) , \qquad ( 2 )$$

where

$${e}_{i}^{{a}_{l}}$$

represents a data element embedding of version l of data element i, i indexes the data elements, aₗ represents the augmentation conducted by transformation l, and f represents the operations performed by the embedding neural network.

At each training iteration, the training system generates a respective score distribution for each embedding of the sampled data element (210). For example, the training system can generate a respective first set of other data element embeddings that includes a first other embedding of the sampled data element and a respective second set of other data element embeddings that includes a second other embedding of the sampled data element. The training system can subsequently process the original first embedding of the sampled data element and the respective first set of other data element embeddings to generate a respective first score distribution, and the original second embedding of the sampled data element and the respective second set of other data element embeddings to generate a respective second score distribution, as is discussed in further detail below with reference to the description of FIG. 3.

At each training iteration, the training system can process the score distributions to update the network parameters of the embedding neural network (212). For example, the training system can update the values of the parameters of the embedding neural network by processing the score distributions to optimize an objective function. The objective function can include a contrastive loss term based on at least the first score distribution (e.g., which attempts to maximize the differences among data element embeddings generated from different data elements), and an invariance term which measures the divergence between the first score distribution and second score distribution (e.g., which attempts to minimize the difference among data element embeddings generated from different versions of the same data element), as will be described in further detail below with reference to the description of FIG. 4 below.

The training system determines if one or more termination criteria have been met (214), e.g., a single criterion testing if a predefined number of training iterations have been performed. If the training system determines that the termination criteria have not yet been met, the training system can loop back to step (202).

If the training system determines that the termination criteria have been met, then the training system terminates the training iteration loop (216).

FIG. 3 is a flow diagram of an example process for generating a first score distribution and a second score distribution for a sampled data element. For convenience, the process 300 will be described as being performed by a system of one or more computers located in one or more locations. For example, a score distribution system, e.g., the score distribution system 300 of FIG. 1, appropriately programmed in accordance with this specification, can perform the process 300.

At each training iteration, the score distribution system receives the first original embedding of the sampled data element, the second original embedding of the sampled data element (e.g., those produced at step 208 in the process 200 with reference to FIG. 2), and the set of data elements (302).

At each training iteration, the score distribution system generates a first other embedding for each data element in the set of data elements (304). For example, to generate a first other embedding of each data element in the set of data elements, the score distribution system can apply a first other transformation from the set of transformations to each data element in the set of data elements to generate a first other version of each data element. The score distribution system can sample the first other transformation from the set of transformations, e.g., by randomly sampling the first other transformation. Generally, the first other transformation can be different from the original first and second transformations used to generate the original first and second embeddings of the sampled data element. The score distribution system can process each first other data element version using the embedding neural network to generate a respective first other embedding of each first other data element version.

At each training iteration, the score distribution system can generate a first score distribution by processing: (1) the original first embedding of the sampled data element, and (2) the first other embeddings of the data elements (306). For example, the score distribution system can generate a projection of each (i.e., original and other) first data element embedding, and generate a first score distribution by processing the first data element embedding projections. The score distribution system can generate a projection of each data first element embedding using a projection neural network. Generating a projection of a data element embedding can be represented as,

$${p}_{i}^{l} = g ( {e}_{i}^{{a}_{l}} ) , \qquad ( 3 )$$

where

$${p}_{i}^{l}$$

represents the projection of a data element embedding of version l of data element i, i indexes the data elements, aₗ represents the augmentation performed by a transformation l,

$${e}_{i}^{{a}_{l}}$$

represents the data element embedding of version l of data element i, and g is the projection neural network.

The projection neural network can have any appropriate neural network architecture that enables it to perform its described function, i.e., processing a data element to generate a projection of the data element embedding. In particular, each projection neural network can include any appropriate types of neural network layers (e.g., fully-connected layers, attention-layers, convolutional layers, etc.) in any appropriate numbers (e.g., 1 layer, 5 layers, or 25 layers), and connected in any appropriate configuration (e.g., as a linear sequence of layers). (A projection of a data element embedding can refer to an alternative representation of the data element embedding, e.g., as an ordered collection of numerical values, e.g., a vector or matrix of numerical values. The projection of a data element embedding can have a lower dimensionality than the data element embedding).

The score distribution system can generate a first score distribution based on the projection of the original first data element embedding and the projections of each first other data element embedding. For example, the score distribution system can generate a first score distribution, where each score in the first score distribution is based on a similarity measure between the projection of the original first data element embedding and a respective first other data element embedding projection in the set of first other data element embedding projections. A similarity measure can be represented, e.g., by a dot product operation:

$${ξ}_{ij}^{lk} = ϕ ( {p}_{i}^{l} , {p}_{j}^{k} ) , \qquad ( 4 )$$

where

$${ξ}_{ij}^{lk}$$

represents the similarity measure between the embedding projection of version l of data element i and the embedding projection of version k of data element j, l and k index the versions, i and j index the data elements, and ϕ represents the dot product. A set of similarity measures can be represented as,

$${Ξ}_{i}^{lk} = \{ {ξ}_{ij}^{lk} \} . \qquad ( 5 )$$

where

$${Ξ}_{i}^{lk}$$

represents the set of similarity measures between an embedding projection of version l of data element i and an embedding projection of version k of each data element j, i and j index data elements, and l and k index versions (i.e., transformations). The set of similarity measures represented by equation (5) is across index j with i, l, and k fixed. The score distribution system can generate a first score distribution from the first set of similarity measures, e.g., by processing the similarity measures using a soft-max function.

At each training iteration, the score distribution system generates a second other embedding for each data element in the set of data elements (308). For example, to generate a second other embedding of each data element in the set of data elements, the score distribution system can apply a second other transformation from the set of transformations to each data element in the set of data elements to generate a second other version of each data element. The score distribution system can sample the second other transformation from the set of transformations, e.g., by randomly sampling the second other transformation. Generally, the second other transformation can be different from the original first and second transformations used to generate the original first and second embeddings of the sampled data element, and from the first other transformation used to generate the first other embeddings of the data elements in the set of data elements. The score distribution system can process each second other data element version using the embedding neural network to generate a respective second other embedding of each second other data element version.

At each training iteration, the score distribution system can generate a second score distribution by processing: (1) the original second embedding of the sampled data element, and (2) the second other embeddings of the data elements (310). For example, the score distribution system can generate a projection of each (i.e., original and other) second data element embedding, and generate a second score distribution by processing the second data element embedding projections. The score distribution system can generate a projection of each second data element embedding using a projection neural network, e.g., as represented by equation (3).

The score distribution system can generate a second score distribution based on the projection of the original second data element embedding and the projections of each second other data element embedding. For example, the score distribution system can generate a second score distribution, where each score in the second score distribution is based on a similarity measure between the projection of the original second data element embedding and a respective second other data element embedding projection in the set of second other data element embedding projections, e.g., as represented by equation (4). The score distribution system can generate a second score distribution from the second set of similarity measures, e.g., by processing the similarity measures using a soft-max function.

Generating the first and second score distributions using a projection neural network can enable the system to compare the similarity between embeddings in a learned projection space, which can enrich the score distributions by allowing them to represent more semantic information. The projection neural network can be jointly trained along with the embedding neural network, as will be described in more detail below.

FIG. 4 is a flow diagram of an example process for updating the current values of the parameters of an embedding neural network by optimizing an objective function which measures the similarity between a first and a second score distribution. For convenience, the process 400 will be described as being performed by a system of one or more computers located in one or more locations. For example, an optimization system, e.g., the optimization system 400 of FIG. 1, appropriately programmed in accordance with this specification, can perform the process 400.

At each training iteration, the system receives the first and second score distributions (402), e.g., those generated at step (210) of the process 200 with reference to FIG. 2.

At each training iteration, the system can generate gradients of an objective function with respect to the current parameter values of the embedding neural network (and, optionally, the projection neural network), e.g., using backpropagation (404). The objective function can include: (i) a contrastive loss term that measures a contrastive loss between the sampled data element and the first score distribution (e.g., which attempts to maximize the differences among data element embeddings generated from different data elements), and (ii) an invariance term that measures the similarity of the first and second score distributions (e.g., which attempts to minimize the differences among data element embeddings generated from different versions of the same data element).

For example, the contrastive loss term that measures the contrastive loss between the sampled data element and the first score distribution can represented as, e.g.:

$${Loss}_{contrastive} = - log \frac{exp ( {ξ}_{ii}^{lk} / τ )}{{Σ}_{j = 1}^{N} exp ( {ξ}_{ij}^{lk} / τ )} , \qquad ( 6 )$$

where

$${ξ}_{ij}^{lk}$$

represents the similarity measure between the embedding projection of version l of data element i and the embedding projection of version k of data element j, τ represents a temperature parameter, the denominator is a sum of the scores in the first score distribution, N is the number of scores in the score distribution, the log function is a log function of an appropriate base (e.g., natural log with base e), l and k index versions of data elements, and i and j index data elements.

The invariance term can be represented by any divergence measure between the first and second score distributions, e.g., a Kullback-Leibler divergence, as

$$KL ( {Λ}_{i}^{lk} , {Λ}_{i}^{q t} ) , \qquad ( 7 )$$

where KL represents the Kullback-Leilber divergence,

$${Λ}_{i}^{lk}$$

represents the first score distribution generated from the first set of similarity measures

$${Ξ}_{i}^{lk} , and {Λ}_{i}^{q t}$$

represents the second score distribution generated from the second set of similarity measures

$${Ξ}_{i}^{q t} .$$

The objective function can be composed of two parts, the contrastive loss term of equation (6) and the invariance term of equation (7), as

$$- log \frac{{λ}_{ii}^{lk}}{{Σ}_{j = 1}^{N} {λ}_{ij}^{lk}} + α \cdot KL ( {Λ}_{i}^{lk} , {Λ}_{i}^{q t} ) , \qquad ( 8 )$$

where the first term represents the contrastive loss of the sampled data element and the first score distribution, the second term represents the divergence between the first and second score distributions, α is a constant used to weight the importance of the divergence term,

$${λ}_{ij}^{lk}$$

represents a score from the first score distribution

$${Λ}_{i}^{lk} ,$$

N represents the number of scores in the first score distribution

$${Λ}_{i}^{lk} , and {Λ}_{i}^{q t}$$

represents the second score distribution.

The contrastive loss represents the relative similarity of (1) embeddings of two different versions of the same data element, and (2) embeddings of different data elements. Optimizing the contrastive loss encourages the embedding neural network to generate more similar embeddings of different versions of the same data element, and less similar embeddings of different data elements. The first term in equation (8) encourages the maximization of differences among embeddings generated from different data elements, and the second term in equation (8) encourages the minimization of differences among embeddings generated from different versions of the same data element.

Optimizing an objective function such the one shown as in equation (8) can enable the system to train the embedding neural network to generate embeddings that are (approximately or exactly) invariant to transformations applied to the data element prior to being processed by the embedding neural network. Training the embedding neural network to generate embeddings which are at least partially invariant under stylistic changes can enable the generated data element embeddings to be more useful for downstream tasks, such as those used in unsupervised learning environments, so that the tasks are performed more efficiently, with greater accuracy, or both. The embedding neural network can then also be trained for the subsequent tasks with fewer training iterations, thereby saving computational resources.

The system can use the gradients of the objective function to update the current parameter values of the embedding neural network, and optionally, the projection neural network (406). The system can conduct the updates using any appropriate method, e.g., stochastic gradient descent, stochastic gradient descent with momentum, or ADAM.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

1. A method performed by one or more data processing apparatus for training an embedding neural network having a plurality of parameters that is configured to process a data element to generate an embedding of the data element, the method comprising:
generating a first embedding and a second embedding of a data element, comprising:
applying a first transformation to the data element to generate a first version of the data element and processing the first version of the data element using the embedding neural network to generate the first embedding of the data element, and
applying a second transformation to the data element to generate a second version of the data element and processing the second version of the data element using the embedding neural network to generate the second embedding of the data element;
generating, for the data element, a respective first score distribution and a respective second score distribution over a set of given data elements that includes the data element, comprising:
processing at least the first embedding of the data element to generate the first score distribution over the set of given data elements, and
processing at least the second embedding of the data element to generate the second score distribution over the set of given data elements; and
updating current values of the embedding neural network parameters to optimize an objective function that measures a similarity between: (i) the first score distribution, and (ii) the second score distribution.
